(19) United States
(12) Patent Application Publication
(10) Pub. No.: US 2008/0191693 A1
(43) Pub. Date: Aug. 14, 2008

(54) System and Methods for Detecting Environmental Conditions

(75) Inventors: Anthony Patrick Jones, Hertfordshire (GB); Martyn Edward Stopps, Hertfordshire (GB)

Correspondence Address: GLAXOSMITHKLINE;CORPORATE INTELLECTUAL PROPERTY, MAI B482, FIVE MOORE DR., PO BOX 13398, RESEARCH TRIANGLE PARK, NC, 27709-3398, US

(73) Assignee: GLAXO GROUP LIMITED, Greenford (GB)

(21) Appl. No.: 11/908,301

(22) PCT Filed: Mar. 9, 2006
(86) PCT No.: PCT/EP06/02482

§ 371 Date: Sep. 11, 2007

(30) Foreign Application Priority Data
Mar. 11, 2005 (GB) 0505089.3

(51) Int. Cl. G01N 27/82

(52) U.S. Cl. 324/238

(57) ABSTRACT

A system for detecting a condition of a package, the package comprising a sensor responsive to electromagnetic induction and having response characteristics dependent on said condition, the system comprising:
an excitation coil magnetically couplable to said sensor; and

a receiving coil system magnetically couplable to said sensor, the receiving coil system being connectable to a processing system for determining the sensor response,
wherein the receiving coil system is arranged so as to control the electromagnetic coupling between at least part of the receiving coil system and said excitation coil.

### FIELD OF THE INVENTION

The present invention relates to methods and systems for use in detecting environmental conditions associated with packages or packaging for products, in particular products for ingestion and for the treatment of medical conditions.

### BACKGROUND OF THE INVENTION

There are many concerns in relation to products having a finite shelf-life such as medicaments and food products. One such concern relates to changes in environmental conditions such as humidity, temperature, pressure, pH and the like, more particularly how these conditions affect the state of the product during their shelf-life. Indeed, various systems and methods exist for predicting moisture ingress within medical dispensers and packaging, but these methods are essentially models based on theory which estimates both changes in actual moisture levels and product response thereto.

Environmental conditions can be measured by means of tuned inductive Inductor-Capacitor (LC) circuits, which, as is known in the art, comprise a capacitor having two electrodes separated by an insulator layer (a dielectric), and an inductor embodied as a loop or coil of wire. The capacitance depends on the size of the configuration of the electrodes and the dielectric constant of the insulator layer, which depends on water content therein, thereby providing a means of measuring humidity. More specifically, since the resonant frequency of the sensor is dependent on the capacitance of the sensor, the sensor can be excited over a range of humidity values and the frequency response corresponding thereto identified, thereby providing a mapping between resonant frequency and humidity conditions. Alternatively, such conditions can be measured by means of sensors comprising Inductor-Capacitor-Resistor (LCR) circuits, whose resistive properties change in dependence on temperature, light levels, pH, gas concentrations and pressure. In the case of LCR circuits, the resistance changes the decay characteristics of the resonant response so that, as for the case with humidity conditions, the sensor can be calibrated over a range of temperatures, light levels etc. and the decay characteristics accurately mapped for future reference.

As stated above, sensors comprising at least an inductor and a capacitor are responsive to the existence of an electromagnetic field so as to resonate under certain conditions. There are various methods and systems for inducing resonance in the sensor: conventionally, an excitation signal is coupled (e.g. by magnetic induction) to the sensor, the signal sweeping across a range of frequencies within which the resonant frequency of the sensor lies; such an arrangement is described in European Patent EP182488. The resonant response of the sensor is then detected by means of a receiver and processed in order to identify characteristics of the response.

Known systems, such as that described in “Design and application of a wireless, passive, resonant-circuit environmental monitoring sensor”, Ong et al. Sensors and Actuators 93 (2001) 33-34, advocate using sensors embodied as Micro-Electro-Mechanical Systems (MEMS) devices, having excitation frequencies in excess of 20 MHz. Such operating frequencies are unsuitable for certain types of sensor environments, in particular when the sensor is contained within packaging, because either or both of the excitation and/or response signal can have difficulties passing through the packaging, and, in the case of electrically conductive packaging, the response and excitation signals can be significantly attenuated.

### SUMMARY OF THE INVENTION

In accordance with a first aspect of the present invention, there is provided a system for detecting a condition of a package, the package comprising a sensor responsive to electromagnetic induction and having response characteristics dependent on said condition, the system comprising:

an excitation coil magnetically couplable to said sensor; and

a receiving coil system being magnetically couplable to said sensor and being connectable to a processing system for determining the sensor response,

wherein the excitation coil is electrically connectable to a signal generator so as to receive a pulsed signal, comprising an edge.

Embodiments of the invention have identified that applying the excitation signal as a pulse, rather than as a swept signal, induces an electromotive force in the inductor of the sensor that is of sufficiently large amplitude that effects of the attenuation of the resonant response are significantly reduced. This is particularly beneficial in relation to electrically conductive packaging, where attenuation can be prohibitively problematic. Preferably the sensor resonates at low frequencies, which, relatively speaking, are less attenuated by conductive packaging materials; accordingly the pulsed signals are preferably applied within the low frequency range.

The system can operate in response to signals capable of exciting resonance of the sensor, which are most conveniently embodied as signals comprising abrupt changes in voltage. Signals comprising such sudden changes in voltage are often referred to as “edges”, and the signal can comprise a single rising edge or falling edge, or comprise one or a plurality of pulses, each comprising a rising edge and a falling edge. Each pulse, and indeed each edge of a pulse, can be separated from a previous pulse (and/or edge) by a predetermined time period or a random interval, and the pulse can be embodied as a frequency pulse train of a configurable swept frequency and/or duty cycle. For edges that are separated by a random interval, the magnitude of the interval is subject to a minimum time period, which is dependent on the decay characteristics of the sensor.

Whilst arrangements according to the first aspect of the invention provide a solution to the attenuation problem, when a pulsed signal is applied to the excitation coil, a transient voltage is unfortunately received via the receiving coil system, limiting the usable gain to a factor of, for example, 100.

Accordingly, in accordance with a second aspect of the present invention, there is provided a system for detecting a condition of a package, the package comprising a sensor responsive to electromagnetic induction and having response characteristics dependent on said condition, the system comprising:

an excitation coil magnetically couplable to said sensor; and

a receiving coil system magnetically couplable to said sensor, the receiving coil system being connectable to a processing system for determining the sensor response,

wherein the receiving coil system is arranged so as to control the electromagnetic coupling between at least part of the receiving coil system and said excitation coil.

Embodiments according to a second aspect of the invention overcome the problem associated with the first aspect, and comprise a means for controlling electromagnetic coupling between at least part of the receiving coil system and the excitation coil. In one arrangement, the receiving coil system comprises two coils, and control of the electromagnetic coupling is provided by adjusting the configuration of at least one of the coils so as to control the switching transient voltage induced in the receiving coil system. In one arrangement the first and second coils can be positioned in different planes, the receiving coil system comprising a mechanism for changing the position of the second coil relative to the excitation coil so as to control the transient voltage level. In another arrangement the receiving coil system comprises a selector for selecting a subset of turns of the second coil, thereby controlling the transient voltage. In a further arrangement a ferrite core of the second coil is adjustable, and in a yet further arrangement the amount of shielding associated with the second coil is adjustable. The actual means employed to control the electromagnetic coupling will, at least in part, be dependent on practical considerations and constraints.

Preferably each of the first and second coils is mounted on a support, the support having corresponding first and second coil support portions; in the case where control of the electromagnetic coupling is provided by modifying the position of the second coil, the support conveniently has an adjustor for adjusting the location of the second coil relative to the excitation coil.

The excitation coil can also be mounted on the support, and, in order to hold the package during detection of the condition, the support can include a support surface or portion for supporting the package. In one arrangement the support surface is disposed between the first coil support portion and at least said further coil support portion. When the package comprises an electrically conductive portion, the second support portion is preferably adjustable so as to move from a first position, in which the second coil is separated from the excitation coil, to a second position, in which the second coil overlaps at least part of the excitation coil. In such a configuration the first coil support portion is preferably disposed between the support surface and the further support potion.

It will be appreciated that, by the phrases “electromagnetic coupling” and “magnetic coupling”, is meant the transfer of energy from one circuit to another (here from the excitation coil to the receiving coil system) by virtue of the mutual inductance between the circuits; this can alternatively be referred to as “inductive coupling”.

According to a third aspect of the present invention there is provided a method of configuring a system for detecting a condition of a package, the package comprising a sensor responsive to electromagnetic induction and having response characteristics dependent on said condition, the method comprising:

mounting a receiving coil system on a support structure, said receiving coil system being electrically connected to a processing system for determining electromotive force induced in said receiving coil system;

mounting an excitation coil on said support structure, said excitation coil being electrically connected to a signal generator so as to receive a one or more pulsed signals;

applying a signal to said excitation coil so as to induce an electromotive force in said receiving coil system; and

adjusting the receiving coil system so as to identify a configuration thereof in which the electromotive force induced therein meets a predetermined condition.

Most preferably the predetermined condition is one in which the transient voltage induced in the receiving coil system is a minimum. In one arrangement the receiving coil system comprises a first coil and a second coil, and aspects of the second coil, relative to the excitation coil, can be modified in order to establish this configuration. In the case of the packaging comprising one or more electrically conductive portions, the method includes placing an electrically conductive portion between the first coil and the excitation coil before performing the adjustment.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing a system comprising an excitation coil and pickup coil arranged to induce and measure resonance in a sensor;

FIG. 2 is a pictorial representation showing voltage induced in the pickup coil of FIG. 1;

FIG. 3 is a schematic diagram showing a system according to an embodiment of the invention comprising an excitation coil and receiving coil system arranged to induce and measure resonance in a sensor;

FIG. 4 is a pictorial representation showing voltage induced in the receiving coil system of FIG. 3 in the absence of a sensor;

FIG. 5 is a schematic side view showing a support structure for the excitation coil and receiving coil system shown in FIG. 3;

FIG. 6 is a pictorial representation showing voltage induced in the receiving coil system of FIG. 3 when a sensor is mounted on the support structure for a first type of excitation signal;

FIG. 7 is a pictorial representation showing voltage induced in the receiving coil system of FIG. 3 when a sensor is mounted on the support structure for a second type of excitation signal;

FIG. 8 is a pictorial representation showing voltage induced in the receiving coil system of FIG. 3 when a sensor is mounted on the support structure for a third type of excitation signal;

FIG. 9 is a pictorial representation showing voltage induced in the receiving coil system of FIG. 3 when a sensor is mounted on the support structure for a fourth type of excitation signal;

FIG. 10 is a pictorial representation showing the relationship between rise time of an excitation pulse and amplitude of sensor resonance;

FIG. 11 is a schematic diagram showing a system according to another embodiment of the invention comprising an excitation coil and receiving coil system arranged to induce and measure resonance in a sensor;

FIG. 12 is a schematic side view showing a support structure for the excitation coil and receiving coil system shown in FIG. 11 in a first position;

FIG. 13 is a schematic side view of a support structure for the excitation coil and receiving coil system shown in FIG. 11 in a second position;

FIG. 14 is a flow diagram showing steps involved in configuring the receiving coil system shown in FIGS. 3 and 5;

FIG. 15 is a schematic diagram showing components of a data collection system for use in collecting data indicative of a relationship between sensor characteristics and environmental conditions; and

FIG. 16 is a pictorial representation showing data collected by the system shown in FIG. 15.

### DETAILED DESCRIPTION OF THE INVENTION

As described above, embodiments of the invention are concerned with inducing resonance of a sensor that is contained within packaging and subject to various environmental conditions. More specifically, embodiments provide a system that induces energy in the sensor via magnetic induction between an excitation coil and the sensor. The excitation coil is driven by one or more pulsed excitation signals having fast edges (short rise and fall times), each of which is capable of inducing resonance of the sensor.

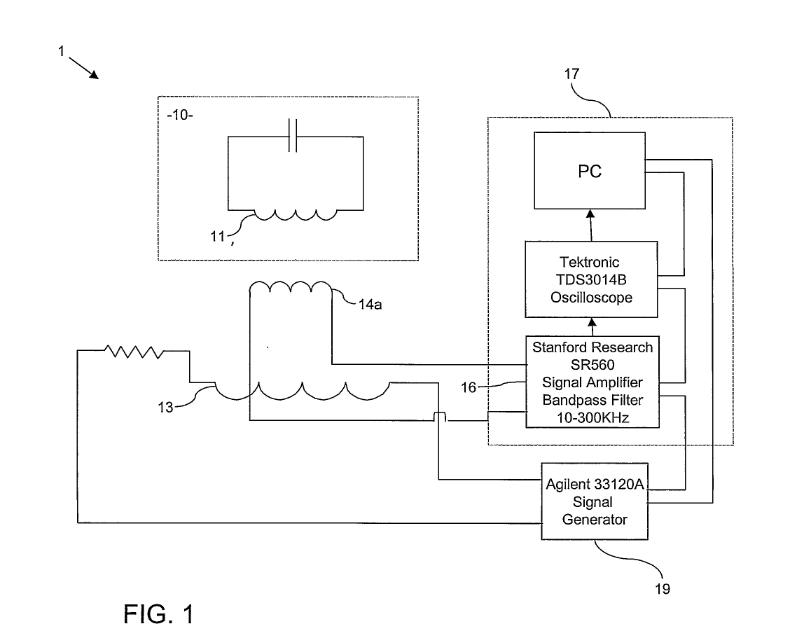

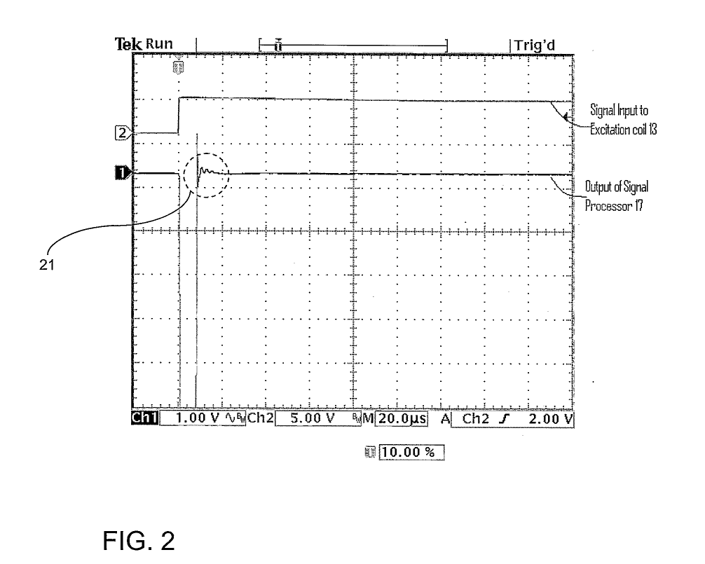

A system 1 embodying such features is shown in FIG. 1, and comprises an LC sensor 11, an excitation coil 13, a pickup coil 14a, a processing system 17 for processing signals received by the pickup coil 14a, and a signal generator 19 for applying a signal to the excitation coil 13. Referring now to FIG. 2, it can be seen that when a pulsed signal is applied the excitation coil 13, a transient voltage is received via the pickup coil 14a. This transient voltage adversely affects the performance of the amplifier 16 forming part of the processing system 17 due to input overloading, thereby limiting the usable gain to a factor of, for example, 100. As can be seen from FIG. 2 (which shows output from the receiving coil system 15 without the sensor in position), the amplifier part of the processing system 17 is overloaded and the initial section of the waveform is severely distorted. In order to identify resonance characteristics of the sensor 11, the pickup signal needs to contain several time periods-worth of the resonance signals; in view of the limited duration of usable signal, and the fact that those portions that are usable are significantly distorted, the system shown in FIG. 1 is significantly limited in its application.

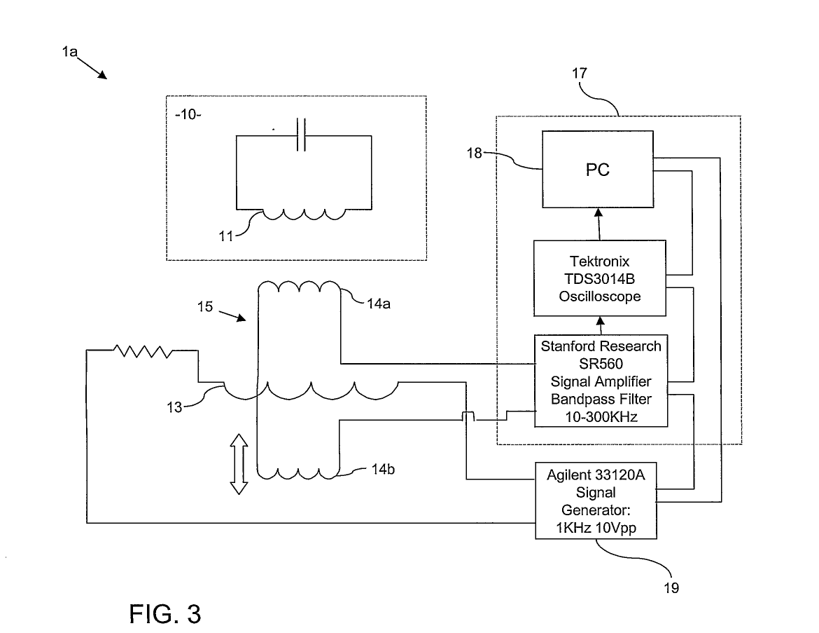

FIG. 3 shows an embodiment of the invention which overcomes the problem associated with the system of FIG. 1. More specifically, system la comprises a receiving coil system 15 arranged so as to control the electromagnetic coupling between at least part of the receiving coil system 15 and the excitation coil 13. In one arrangement, the receiving coil system 15 comprises two coils 14a, 14b, the second of which 14b can be adjusted relative to the excitation coil so as to control the transient voltage. In the specific arrangement shown in FIG. 3, the position of the second coil 14b can be adjusted, but the number of turns, shielding, or ferrite core (and any combination of these attributes) could alternatively be adjusted. Moreover, whilst FIG. 3 shows the coils making up the receiving coil system 15 as being located in two different planes, they could alternatively be placed in same horizontal plane, in which case control of the electromagnetic coupling would be by means of lateral movement, or the number of turns, or shielding, or ferrite core or any combination thereof.

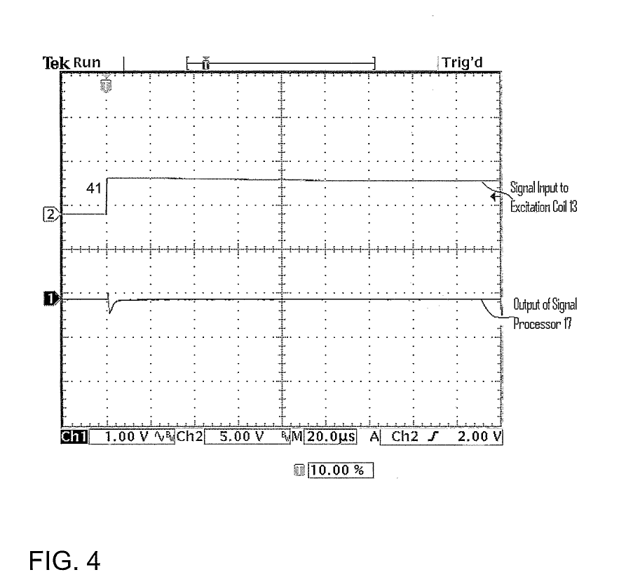

Turning to FIG. 4, it can be seen that the receiving coil system—more particularly the configuration of the second coil relative—can be adjusted so that the amplified pickup signal comprises very little distortion from transients in response to a pulsed signal (having rising edge 41). This then makes possible high gain amplification of the response of the sensor 11.

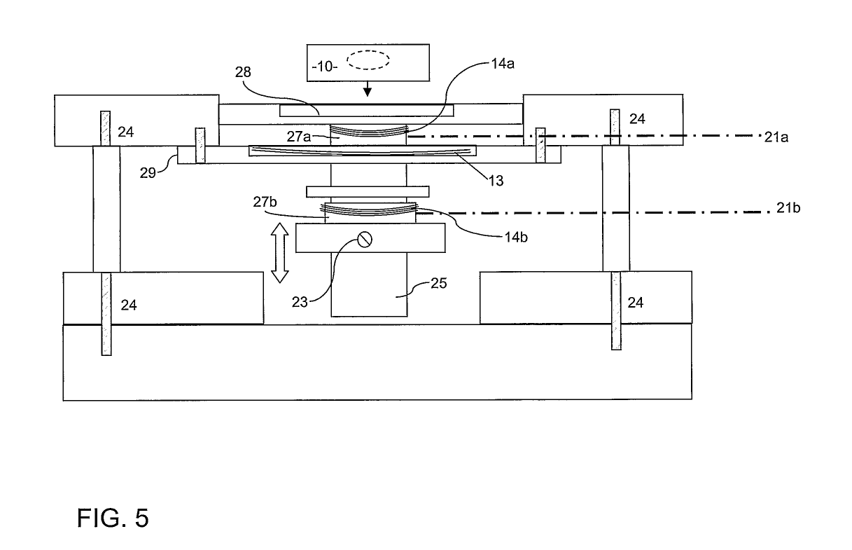

Turning now to FIG. 5, a structure for locating the excitation coil and receiving coil system, for the example arrangement shown in FIG. 3, will be described. Each of the first and second coils is located in a plane 21a, 21b and mounted on a support 25, which has corresponding first and second coil support portions 27a, 27b. The support 25 additionally comprises an adjustor 23 for adjusting the location of the second coil relative to the excitation coil. In the simplest arrangement the adjustor is embodied as a grub screw which passes through the second coil support portion 27b and engages or disengages with the support body 25 so as to lock or free, respectively, the second support portion 27b relative to the support body 25. When the second support portion 27b is free, it can be moved along the length of the support body 25, thereby changing the position of the second coil 14b relative to the excitation coil 13. The excitation coil is mounted on a further support portion 29 of the support 25, and the various portions 27a, 27b, 29 are stabilized by means of several plates (not labeled), which are interconnected by means of securing means such as screws 24 (of which only a few are labeled in the Figure). The structure also includes a surface 28 for supporting package 10 comprising the sensor 11.

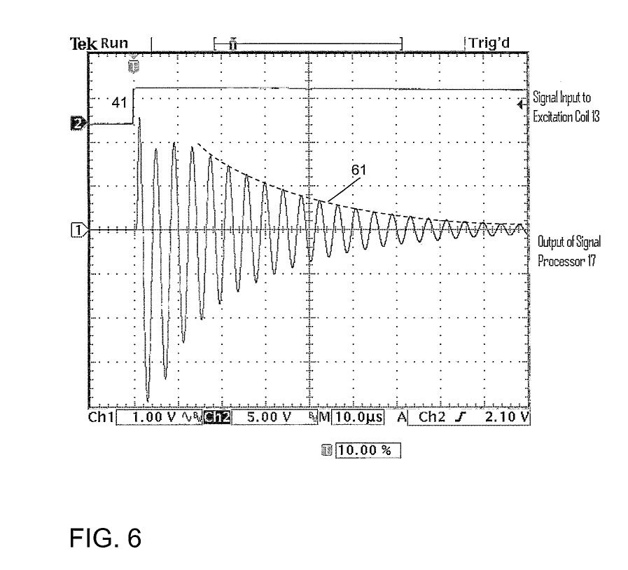

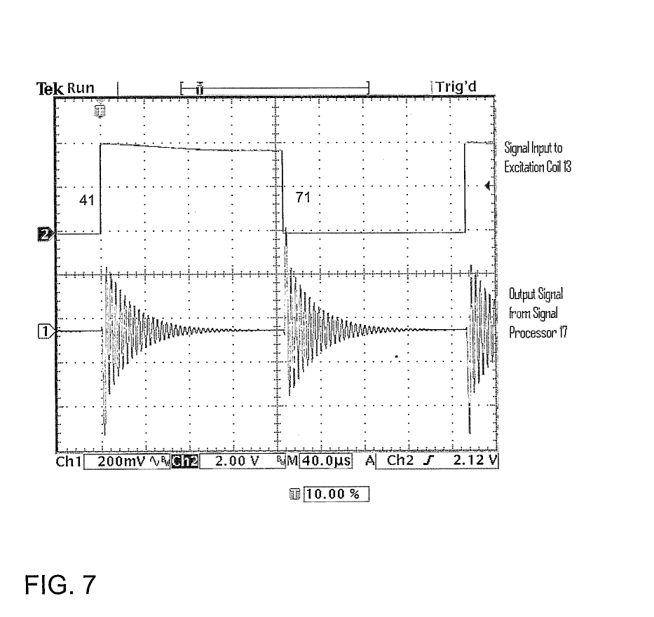

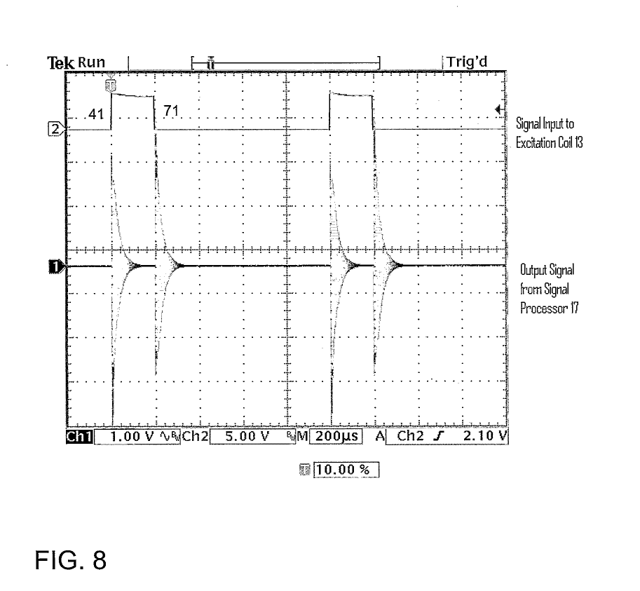

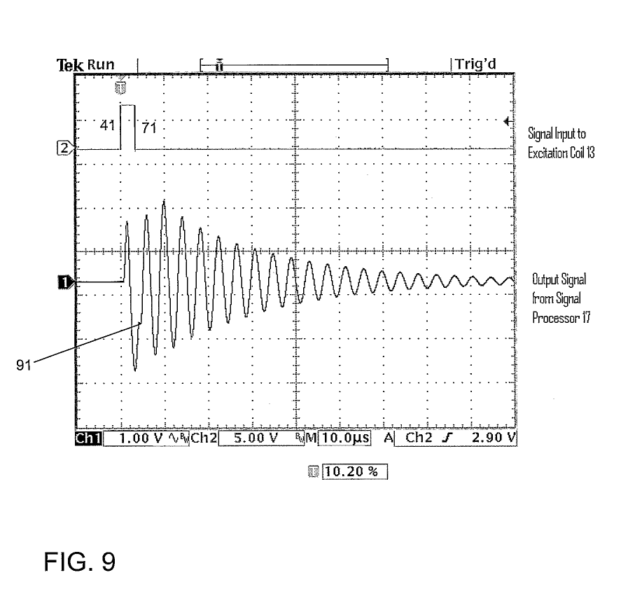

FIG. 6 shows the output of the signal processor 17 when the sensor 11 is positioned on the surface 28, in response to a rising edge 41 of a pulsed signal being applied to the excitation coil 13. As can be seen, the receiving coil system 15 picks up the resonant response of the sensor 11 with little or no distortion. FIG. 7 shows the output in response to rising and falling edges 41, 71 of a pulsed signal having a 50% duty cycle; FIG. 8 shows same, but in relation to a pulsed signal having 20% duty cycle; FIG. 9 shows same, but in relation to a single pulse signal. In relation to FIG. 9, it can be seen that the pulse comprises a leading and falling edge 41, 71, separated by a short delay; inspection of the response of the sensor 11 shows that the delay is shorter than the time taken for resonance of the sensor 11 to decay, and actually triggers a second, interfering resonance behaviour as indicated by label 91. This contrasts with the pulsed input signal shown in FIG. 8, which, having a duty cycle of 20%, results in the rising and falling edges 41, 71 being separated by a period greater than the time taken for resonance of the sensor 11 to decay.

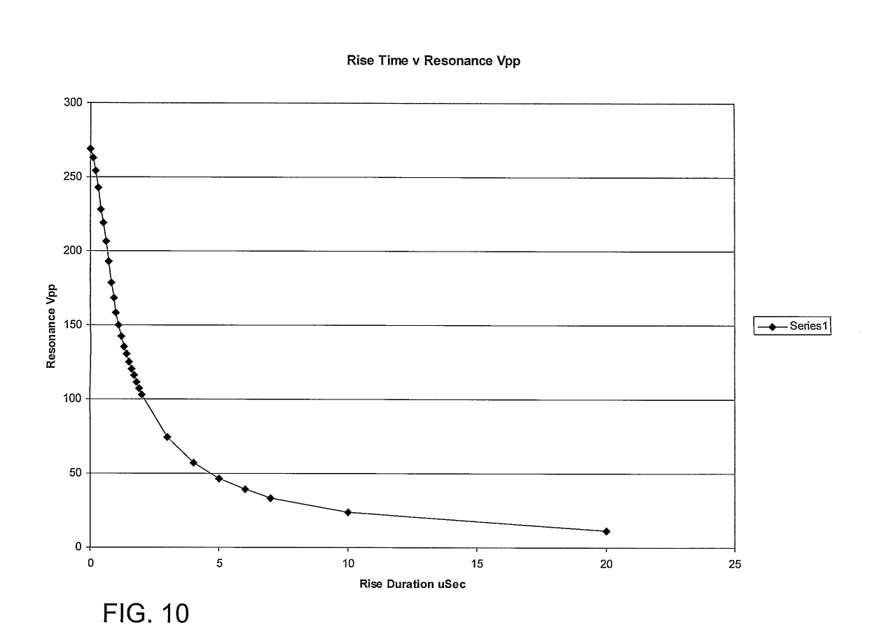

As shown in FIGS. 4 and 6-9, the sensor 11 can be excited by means of a pulsed signal having sharp rising and/or falling edges 41, 71. The technical feature responsible for resonance is associated with the rate of change in current flowing through the excitation coil 13, since this causes an electromotive force to be induced in the inductor of sensor 11 at a particular rate. More specifically this input pulse can be considered to represent an average of a plurality of signals, one of which corresponds to the resonant frequency of the sensor 11. Accordingly it will be appreciated that input signals having, for example, rounded off edges at the start and end of the rise (and fall) of each pulse could be used to energise the excitation coil 13, provided the pulse contains a plurality of signals corresponding to the resonant frequency of the sensor 11. FIG. 10 shows the relationship between resonant response and rise time of the input pulse (i.e. ability to induce resonance of the sensor). As can be seen, the slower the rise time, and thus the slower the rate of change of current through the excitation coil 13, the lower the amplitude of the resonant response.

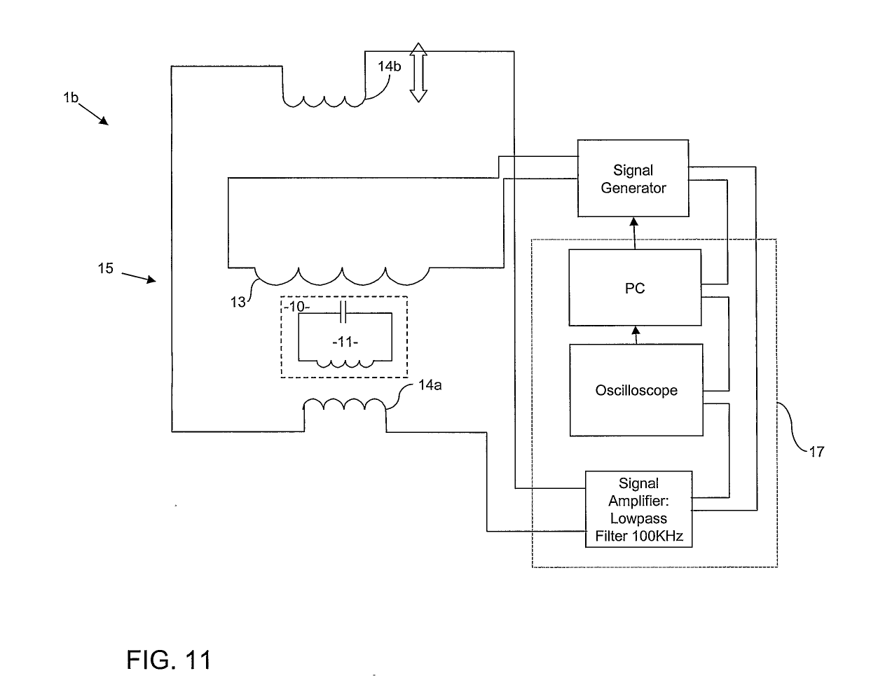

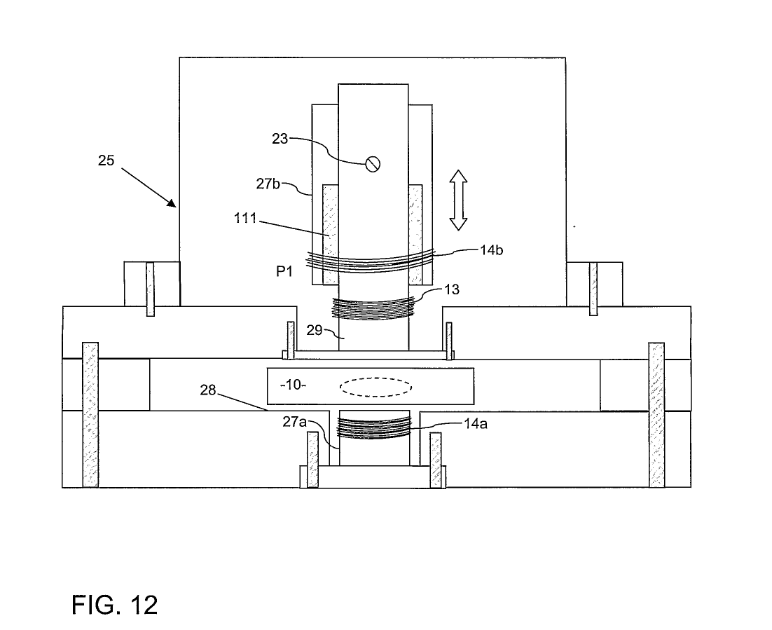

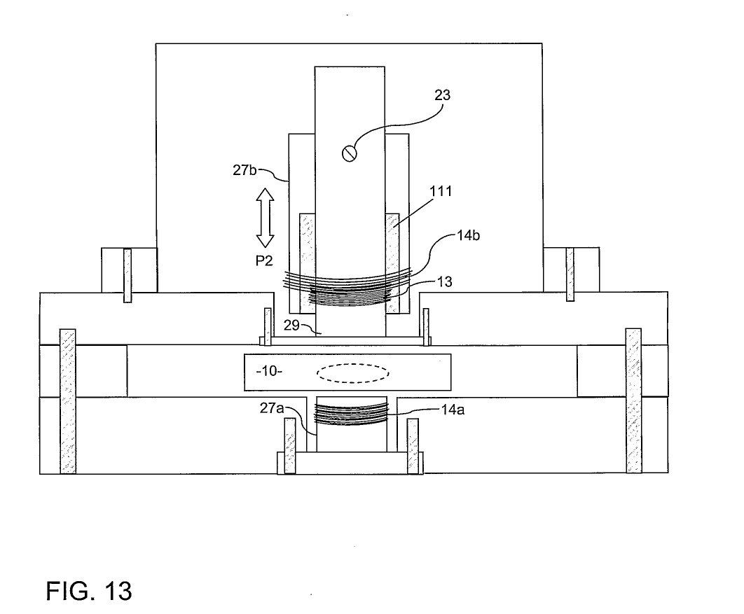

Turning now to FIG. 11, an alternative arrangement 1b will now be described in which the receiving coil system is distributed around the sensor 11, and the magnetic field extending between the pick-up coil 14a, excitation coil 13 and sensor 11 is concentrated within a confined region so as to concentrate the magnetic field and maximise the amplitude of detectable sensor response. This arrangement 1b is therefore particularly well suited to measurement of conditions within packages 10 comprising, at least in part, electrically conductive portions (e.g. metallic sheet), by which the sensor 11 response is significantly attenuated, introducing the possibility of excitation artefacts being a significant component of the signal received by the receiving coil system 15. Referring also to FIGS. 12 and 13, the second coil 14b is arranged on an outside surface of the second support portion 27b, which comprises a hollow portion 111 for enabling the portion 27b—and indeed second coil 14b—to slide over the excitation support portion 29 (and coil 13) from a first position P1 to a second position P2. This overlapping feature provides a means of further increasing the range of adjustment of the receiving coil system 15, thereby improving the possibility of identifying a configuration in which the transient voltage is at a minimum level. In this arrangement, the support surface 28—and thus package 10—is positioned between the excitation coil and the first coil 13, 14a.

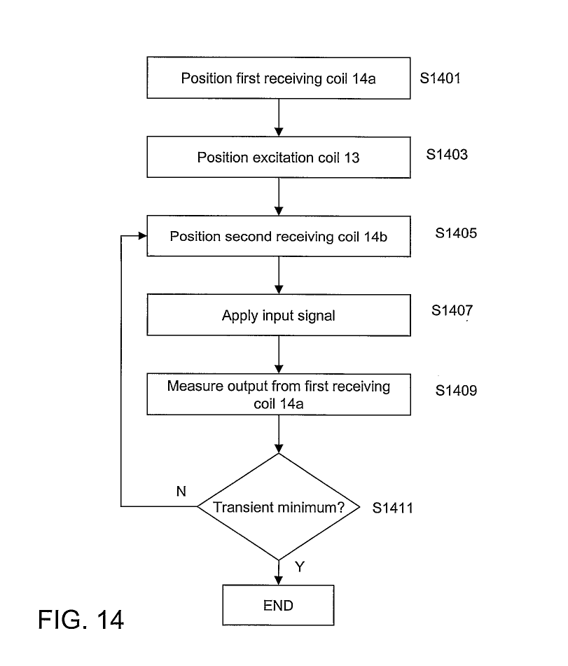

As will be appreciated from the foregoing, and in particular FIG. 4, the receiving coil system 15 requires configuring in order to identify an arrangement in which the effects of transient voltages are reduced. The steps involved in one such procedure are shown in FIG. 14, to which reference will now be made. At steps S1401 and S1403 the first coil 14a and excitation coil 13 are positioned on the support 25. The second coil 14b is then positioned (S1405), and a signal applied to the excitation coil 13 (S1407). The signal induced in the receiving coil system 15 is measured by the processing system 17 (step 1409) and the position of the second coil 14b is adjusted until the magnitude of the transient voltage is at a minimum. The position of the second coil 14b then defines the preferred configuration of the receiving coil system 15. In the case of packaging comprising one or more electrically conductive portions, the configuration method comprises a further step, namely positioning of a representative conductive portion prior to applying a signal to the excitation coil 13.

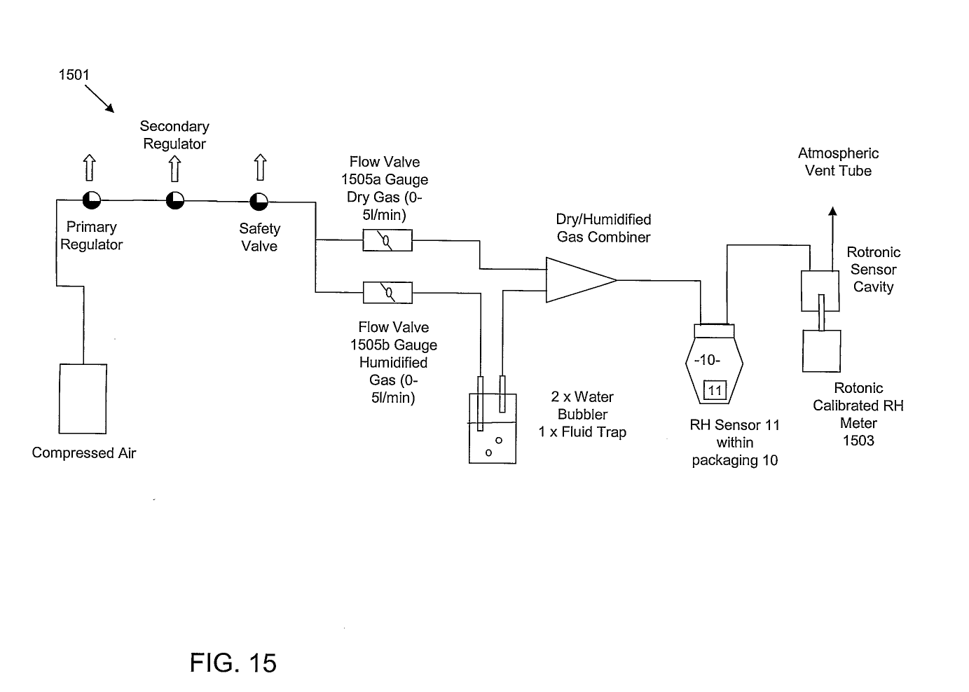

As described above, the system can be used to determine sensor response for a range of environmental conditions, thereby providing a repository of reference data that can be used to validate predictive models and/or as a reference for testing packaging as part of a product monitoring and validation exercise. By way of example only, and with reference to FIG. 15, apparatus will now be described for use in obtaining frequency response over a range of humidity conditions. FIG. 15 shows calibration apparatus 1501 that generates a relative humidity in the range of approximately 2-95%; the humidified gas passes through the package 11 and through a chamber comprising an already calibrated Relative Humidity (RH) reference meter 1503. The humidity is manually controlled by adjustment of two flow valves 1505a, 1505b so as to control the combination of dry and humidified gas. The flow valves 1505a, 1505b are adjusted so as to set a plurality of humidity conditions, and, for each condition, the resonant response of the sensor 11 is measured by means of measuring system 1 (not shown in FIG. 15).

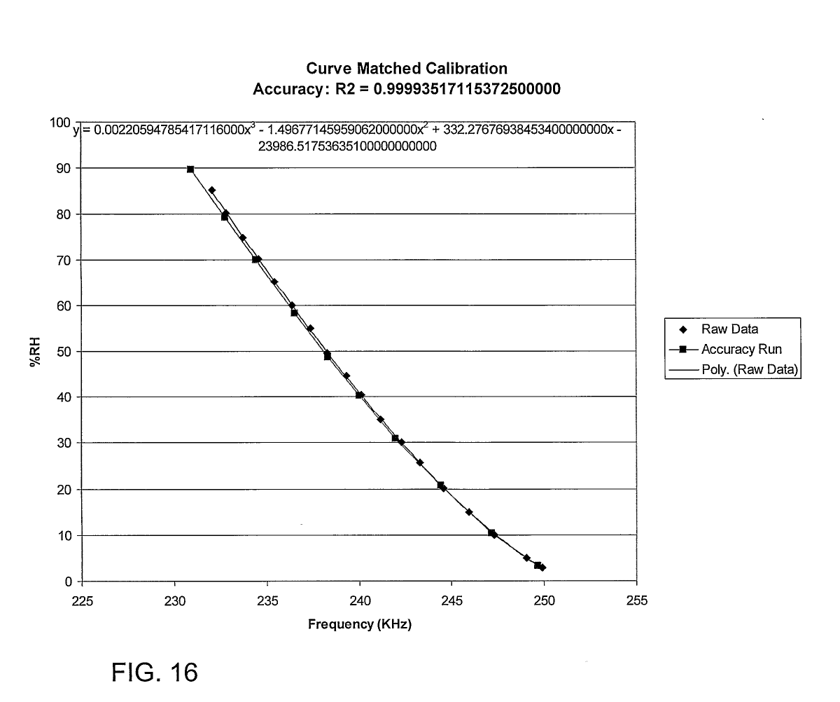

Referring back to FIG. 3, the processing system 17—more specifically the computer 18—comprises processing unit (CPU), memory, hard disc drive and I/O device, which facilitates interconnection of the computer with the other components of the processing system 17. Operating system programs are stored on the hard disc drive, and control, in a known manner, low level operation of the computer 18. The computer also includes a display and keyboard (not shown), which receive input from an operator and pass, via I/O device, input to the O/S programs in accordance with known techniques. In addition to these conventional components, the computer 18 is configured with bespoke computer software for receiving data indicative of resonant response, for analyzing the frequency thereof and for storing data indicative of the same in association with data indicative of the RH values, as measured by the calibrated humidity meter 1503. The software comprises an approximation function (not shown) for identifying a general expression characterizing the relationship between humidity and resonant response; an output of the software for a range of humidity conditions is shown in FIG. 16.

The expression (in this case a polynomial) can then be used to estimate humidity in respect of packages comprising a sensor 11 and which are placed on or within the testing area 28, and for which data indicative of resonance characteristics are obtained.

The foregoing description makes mention of the various ways of modifying the configuration of the receiving coil system 15: namely by changing the position of a second coil 14b relative to the excitation coil 13; and/or by selectively modifying the number of turns making up a second coil 14b; and/or by modifying the extent and type of ferrite core associated with a second coil 14b; and/or by applying a configurable amount of shielding to a second coil 14b. In relation to shielding, modifications to inductance between the receiving coil system 15 and the excitation coil 13 can be effected via some level of magnetic shielding. In the case of turns of the second coil 14b, modifications thereto could be effected by tapping means (not shown), which forms a connection at various points along the windings of the second coil 14b, thereby modifying the number of active windings associated with the second coil 14b. In relation to modifying the ferrite associated with the receiving coil system 15, the second coil 14b could be arranged such that there is a certain amount of relative movement between the ferrite core and windings, the core being associated with an adjusting mechanism which is operable to move the ferrite core relative to the windings through several positions. Whilst the arrangements illustrated in FIGS. 5, 12 and 13 show the receiving coil system 15 comprising two coils 14a, 14b, each located in a different horizontal plane, the two coils could be positioned in the same horizontal plane, and the inductance between the excitation coil 13 and the second coil 14b be modified by lateral movement of the second coil 14b relative to the excitation coil 13.

Whilst in the above description the sensor is described as comprising a tuned LC circuit, the sensor could alternatively comprise an LCR circuit, where changes in resistance of the tuned circuit can be measured from changes in the decay characteristics of the resonant response. Decay characteristics, within the context of embodiments of the invention, can best be explained with reference to FIG. 6, more specifically curve 61, which defines an outer envelope of the resonant response of the sensor 11. A variation in resistance of the sensor 11 results in a modification to the slope of curve 61, and, as is described above for the case of humidity the response of the sensor 11 for each of temperature, pressure, pH, light levels etc. (each resulting in a variation in resistance of the sensor 11) would be calibrated in order to attribute various curve shapes 61 to particular environmental conditions (and combinations thereof). The software described above in the context of measuring humidity would further include an algorithm for identifying an expression describing curve 61. Preferably the algorithm identifies the peaks of each resonant cycle and identifies an expression that includes each peak as a point along curve 61.

The skilled person will appreciate that the receiving coil system 15 and excitation coil 13 can be embodied by a range of different components; by way of example only, in the arrangement shown in FIG. 3, the first and second coils 14a, 14b can comprise a loop having 3 turns of Kynar™ wire, the loop having a diameter of 10 mm, while the excitation coil 13 can comprise a loop having 25 turns of Kynar™ wire, the loop having a diameter of 45 mm. When sensor 11 is embodied as an LC sensor, the coil can be a Surface Mount Device (SMD) Inductor, available from Coilcraft with Part No. DO1605T-105KXB, and having an inductance of 1 mH, and the capacitor can be a Gefran RH Sensor, Part No. H6100, having a nominal capacitance of 500 pF @75% relative humidity. In relation to the arrangement shown in FIG. 11, the first coil 14a can comprise a loop having 4 turns of Kynar™ wire, the loop having a diameter of 10 mm; the second coil 14b can comprise a loop with 10 turns of Kynar™ wire, the loop having a diameter of 15 mm, while the excitation coil 13 can comprise a loop of 25 turns of Kynar™ wire, the loop having a diameter of 10 mm. In relation to a sensor 11 being embodied as an LC sensor, the coil can be an SMD Inductor, EPCOS Part No. B82442A1106K, rated at 10 mH, and the capacitor can be a Gefran RH Sensor, Part No. H6100, having a nominal capacitance of 500 pF @75% relative humidity.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A system for detecting a condition of a package, the package comprising a sensor responsive to electromagnetic induction and having response characteristics dependent on said condition, the system comprising:
an excitation coil magnetically couplable to said sensor; and
a receiving coil system magnetically couplable to said sensor, the receiving coil system being connectable to a processing system for determining the sensor response,
wherein the receiving coil system is arranged so as to control the electromagnetic coupling between at least part of the receiving coil system and said excitation coil.

2. A system according to claim 1, wherein the receiving coil system comprises a first coil and a second coil.

3. A system according to claim 2, wherein the second coil is configurable so as to take up one of a plurality of selectable configurations relative to the first coil, and thence to control said electromagnetic coupling.

4. A system according to claim 2, wherein the second coil is coaxial with the first coil.

5. A system according to claim 2, wherein the first coil is positioned in a first plane and said second coil is positioned in a second plane.

6. A system according to claim 5, wherein the first plane is different to said second plane.

7. A system according to claim 2, wherein the receiving coil system comprises a mechanism for changing the position of the second coil relative to the excitation coil.

8. A system according to claim 5, wherein each of the first and second coils is mounted on a support, the support having corresponding first and second coil support portions and comprising an adjustor for adjusting the location of the second coil relative to the excitation coil.

9. A system according to claim 8, wherein the excitation coil is mounted on a further support portion of the support.

10. A system according to claim 8, wherein each said first and second coil support portion is disposed on one side of the excitation coil.

11. A system according to claim 8, wherein said first coil support portion and said second coil support portion are disposed on opposed sides of the excitation coil.

12. A system according to claim 8, wherein the second support portion is adjustable so as to move from a first position to a second position in which the second coil overlaps at least part of the excitation coil.

13. A system according to claim 2, wherein said each coil of the receiving coil system comprises a set of a plurality of turns and the receiving coil system comprises a selector for selecting a subset of turns of one said coil, said selected subset forming part of the receiving coil system.

14. A system according to claim 13, wherein the selector is arranged to select a subset from the set of turns of the second coil.

15. A system according to claim 2, wherein each said coil of the receiving coil system comprises a set of turns and a ferrite core, the ferrite core of one said coil being adjustable relative to its respective set of turns so as form part of the receiving coil system.

16. A system according to claim 15, wherein the ferrite core of the second coil is adjustable.

17. A system according to claim 1, including magnetic shielding, the magnetic shielding being adjustable relative to the excitation coil.

18. A system according to claim 8, wherein the support comprises a support surface for supporting the package.

19. A system according to claim 18, wherein the support surface is disposed between the first coil support portion and at least said further coil support portion.

20. A system according to claim 18 wherein at least part of the first coil support portion is disposed between the support surface and the further support portion.

21. A system according to claim 8, in which the support structure is formed from one or more inter-connectable parts.

22. A system according to claim 1, wherein the excitation coil is electrically connectable to a signal generator so as to receive a signal capable of exciting resonance in the sensor.

23. A system according to claim 22, wherein the signal comprises an abrupt change in voltage.

24. A system according to claim 22, wherein the signal comprises a pulsed signal.

25. A system according to claim 22, wherein the signal comprises a plurality of pulsed signals.

26-63. (canceled)
